(19) United States
(12) Patent Application Publication
(10) Pub. No.: US 2020/0340627 A1
(43) Pub. Date: Oct. 29, 2020

(54) COMBUSTIBLE GAS PURGE SYSTEM

(71) Applicant: Joshua D. Ott, Norwalk, OH (US)

(72) Inventor: Joshua D. Ott, Norwalk, OH (US)

(21) Appl. No.: 16/855,112

(22) Filed: Apr. 22, 2020

Related U.S. Application Data
(60) Provisional application No. 62/838,018, filed on Apr. 24, 2019.

(51) Int. Cl. F17D 3/10; F04F 5/20; F04F 5/46

(52) U.S. Cl. CPC F17D 3/10; F04F 5/46; F04F 5/20

(57) ABSTRACT

A gas purging device for removing hazardous gas from a gas line has a main body with a first end and a second end. The main body has a major exterior wall extending from a first end to a second end of the main body, and an inner surface that defines a cavity of the main body. The cavity is in fluid communication with the first opening and the second opening of the main body. An airflow conduit is disposed through the major exterior wall of the main body. The airflow conduit has a first section and a second section. The first section is disposed outside of the main body and has an air inlet. The second section is disposed in the cavity and has an air outlet. A grounding wire is in electrical communication with the major exterior wall of main body.

### CROSS-REFERENCE TO RELATED APPLICATIONS

This application claims the benefit of U.S. Provisional Application Ser. No. 62/838,018, filed on Apr. 24, 2019. The entire disclosure of the above application is hereby incorporated herein by reference.

### FIELD

The present disclosure relates generally to a gas purging device and, more specifically, to a gas purging device for removing hazardous gases from a gas pipeline.

### BACKGROUND

Pipelines are used throughout the world to reliably transport energy. Natural gas is the predominant product found in gas pipelines and is important for residential, commercial, and industrial use. Though pipelines transporting natural gas are generally considered extremely safe, they are not without incident. Natural gas is known to be easily ignited by heat, sparks or flames.

Prior to performing inspections or repairs on a section of gas pipeline, hazardous gas from the appropriate section of pipeline must be removed to ensure a safe working environment. Likewise, if a section of pipeline is no longer in use, the gas must be removed prior to the section of pipeline being taken out of service.

There are various known ways to remove hazardous gas from a pipeline. For example, a system for vacuum-purging gas into a filling container in a vacuum state prior to purging is described in WIPO International Publication Number 2005/036603A1. Also, Japan Patent Application Number 2009-180300 describes a method in which air is blown into a pipe replacing the hazardous gas in the pipe with inert air. Various other methods including pump-down techniques using in-line compressors, portable compressors, and ejectors are also known.

While these known devices and methods for purging gas from a pipeline are useful in removing hazardous gas, they are often cumbersome, expensive to install and operate, and require additional components to connect with a pipeline. Additionally, known devices often do not operate independently from a controlled shut-off of the gas line.

There is a continuing need for a gas purging device, system, and method that is convenient and easy-to-use, adaptable to various industry standards, cost effective, and connects directly to a gas pipeline while operating independently from a controlled gas line shut-off.

### SUMMARY

In concordance with the instant disclosure, a gas purging device, system, and method that is convenient and easy-to-use, adaptable to various industry standards, cost effective, and connects directly to a gas pipeline while operating independently from a controlled gas line shut-off, has been surprisingly discovered.

In one embodiment, a gas purging device has a main body with a first end and a second end. The first end defines a first opening, and the second end defines a second opening. The main body has a major exterior wall extending from the first end to the second end and an inner surface that defines a cavity of the main body. The cavity is in fluid communication with the first opening and the second opening of the main body. An airflow conduit is disposed through the major exterior wall of the main body and has a first section and a second section. The first section is disposed outside of the main body and has an air inlet, and the second section is disposed in the cavity and has an air outlet. A grounding wire is in electrical communication with the major exterior wall of main body.

In another embodiment, a gas purging system includes a gas purging device, a gas line, an air compressor, and a purging stack. The gas purging device has a main body with a first end and a second end. The first end defines a first opening, and the second end defines a second opening. The main body has a major exterior wall extending from the first end to the second end and an inner surface that defines a cavity of the main body. The cavity is in fluid communication with the first opening and the second opening of the main body. An airflow conduit is disposed through the major exterior wall of the main body and has a first section and a second section. The first section is disposed outside of the main body and has an air inlet, and the second section is disposed in the cavity and has an air outlet. A grounding wire is in electrical communication with the major exterior wall of main body. The gas line has a first end and a second end. The first end has a gas line air inlet and the second end has a gas line air outlet. The gas line air inlet has an inlet valve disposed therein and the gas line air outlet has a gate valve disposed therein. The gate valve is in communication with the gas purging device. The air compressor is in fluid communication with the air inlet of the airflow conduit of the gas purging device, and the purging stack is in fluid communication with the second end of the main body of the gas purging device.

In a further embodiment, a method of purging gas from a gas line includes a first step of providing a gas purging device. The gas purging device has a main body having a first end and a second end. The first end defines a first opening, and the second end defines a second opening. The main body has a major exterior wall extending from the first end to the second end and an inner surface that defines a cavity of the main body. The cavity is in fluid communication with the first opening and the second opening of the main body. An airflow conduit is disposed through the major exterior wall of the main body and has a first section and a second section. The first section is disposed outside of the main body and has an air inlet, and the second section is disposed in the cavity and has an air outlet. A grounding wire is in electrical communication with the major exterior wall of main body. In a second step, a gas line is provided. The gas line has a first end and a second end. The first end has a gas line air inlet and the second end has a gas line air outlet. The gas line air inlet has an inlet valve disposed therein and the gas line air outlet has a gate valve disposed therein. The gate valve is in communication with the gas purging device. The method includes the additional steps of shutting off a flow of gas to the gas line, connecting the first end of the main body of the gas purging device to the gas line air outlet of the gas line, connecting the first section of the airflow conduit of the gas purging device to an air compressor, connecting the second end of the main body of the gas purging device to a purging stack, and opening the inlet valve of the gas line and the gate valve of the gas line. A final step is activating the air compressor to cause a first flow of air through the airflow conduit into the purging stack at a high velocity, whereby, due to the Venturi effect, the first flow of air creates a negative pressure in the main body of the gas purging device that pulls a second flow of air from the gas line, through the purging stack, and into the atmosphere.

In yet another embodiment, a combustible gas purging system has an air mover including an outer pipe with an inlet end and an outlet end. The inlet end is threaded such that it can be received by a gate valve attached to a branch nipple. The outlet end is threaded such that a gas stack can be connected. The air mover has a Venturi tube inserted into the outer pipe. The Venturi tube enters the outer pipe and bends to become concentric with the outer pipe. The Venturi tube has an intake end and an exhaust end. The intake end of the Venturi tube is configured to receive air from an air compressor. The Venturi tube is sealed such that the air paths of the Venturi tube and the outer pipe remain separated until the exhaust end of the Venturi tube. The air mover also includes an attached grounding wire. The grounding wire is welded or soldered to the outer pipe at one end. The grounding wire may be welded or attached to a grounding tab. The grounding tab includes a surface shaped to aid welding or attachment to the outer pipe. The opposite end of the grounding wire includes a wire or alligator clip to allow easy attachment to an electrical ground. The grounding wire militates against electric discharge which may result in dangerous combustions of the gases within the piping. The Venturi tube enters the outer tube at the approximate midpoint between the inlet end and the outlet end of the outer tube. The Venturi tube enters the outer tube at an angle to provide air directed towards the outlet end of the outer tube. The bend in the Venturi tube provides an obtuse angle for an airpath when air is provided by a compressor and introduced at the intake end. The obtuse angle of the bend reduces chances of flow separation and turbulent flow within the air stream at high Reynolds numbers. In certain embodiments, the bend in the Venturi tube is approximately 120 degrees. The gas purging system is configured to remove combustible gas from a properly isolated section within an operating pipeline in compliance with United States gas utility specifications and ASTM (American Society for Testing and Materials) international regulations. The outer pipe is a 2-inch inner diameter, schedule 40, black steel pipe. The threading of the inlet and exhaust ends has a pitch of 11.5 threads per inch (or 0.08696) to comply with the national pipe thread tapered (NPT) U.S. standard. The Venturi tube is a ½ inch, schedule 40 steel pipe. The inlet end of the Venturi tube is threaded to receive a compressed air line attachment. The air mover has an inlet end attached to a gate valve. The gate valve is attached to a branch nipple of a gas piping line. The air mover evacuates gas from the gas piping line without introducing air. A riser stack is provided to elevate the evacuated gas at a height compliant with utility regulations. The ends of the air mover are threaded male fittings, allowing the inlet end to be threaded into the female threads of the gate valve. The gate valve is provided with female, threaded ends such that it can thread onto the branch nipple at the end of a piping system and receive the air mover at the opposite end. The gate valve is further provided with a rotatable valve to seal off or close the branch nipple of the gas piping system to militate against gas escaping from the piping system.

In yet another embodiment, the combustible gas purging system is a kit. The kit includes an air mover having two threaded male ends. The kit includes a set of riser stacks. Each riser stack has a male threaded end and a female threaded end, such that the riser stacks can be easily attached to one another to form a riser stack with a height compliant with utility regulations. The outer pipe of the air mover and the riser stacks have a 2-inch diameter.

### DRAWINGS

The above, as well as other advantages of the present disclosure, will become readily apparent to those skilled in the art from the following detailed description, particularly when considered in the light of the drawings described hereafter.

FIG. 1 is a front perspective view of a gas purging device according to one embodiment of the present disclosure;

FIG. 2 is a side elevational view of a gas purging device according to another embodiment of the present disclosure;

FIG. 3 is a top plan view of the gas purging device shown in FIG. 2;

FIG. 4 is a cross-sectional side elevational view taken through line A-A of the gas purging device of FIG. 3, the gas purging device shown in fluid communication with a gas line;

FIG. 5 is a side elevational view of a gas purging system according to another embodiment of the present disclosure; and

FIG. 6 is a flow diagram showing a method of purging gas from a gas line using the gas purging device according to FIGS. 1-5.

### DETAILED DESCRIPTION

The following detailed description and appended drawings describe and illustrate various embodiments of the invention. The description and drawings serve to enable one skilled in the art to make and use the invention and are not intended to limit the scope of the invention in any manner. Regarding methods disclosed, the order of the steps presented is exemplary in nature, and thus, the order of the steps can be different in various embodiments.

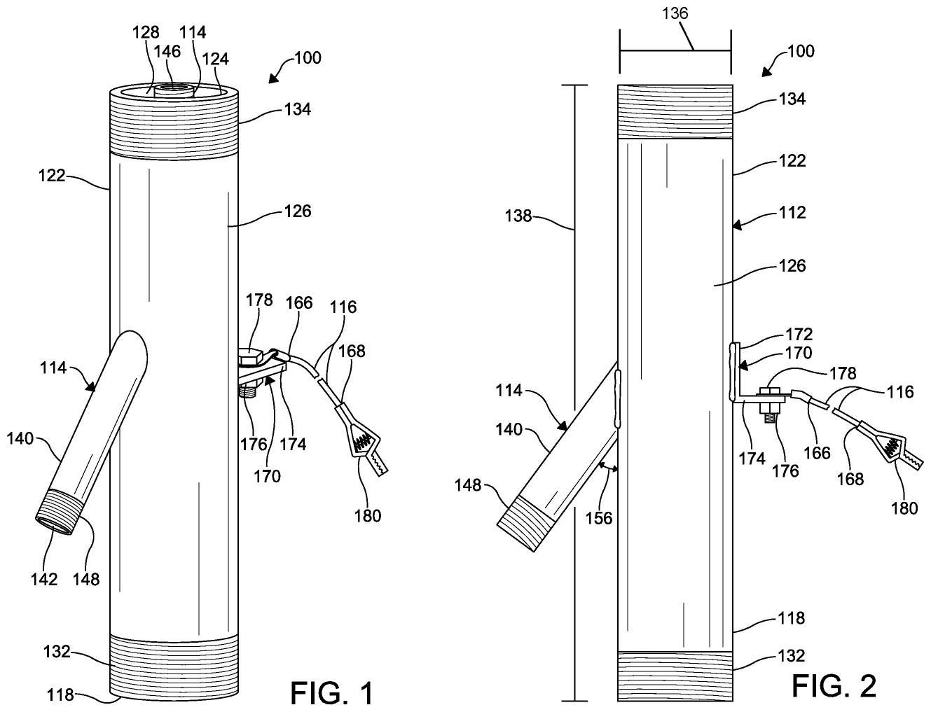

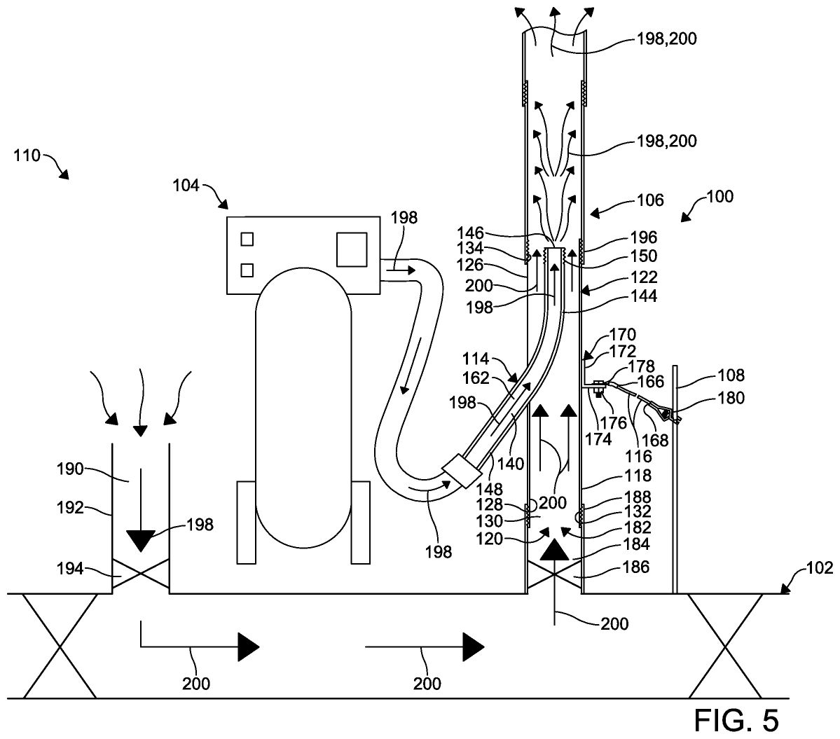

A gas purging device 100 according to various embodiments of the present disclosure is shown in FIGS. 1-5. The gas purging device 100, in combination with a gas line 102, an air compressor 104, a purging stack 106, and a grounding rod 108, form a gas purging system 110, as shown in FIG. 5. In various embodiments, the gas purging device 100 includes a main body 112, an airflow conduit 114, and a grounding wire 116.

The main body 112 of the gas purging device 100 has a first end 118 and a second end 122. The first end 118 has a first opening 120 and the second end 122 has a second opening 124. The main body 112 has a major exterior wall 126 extending from the first end 118 to the second end 122. The major exterior wall 126 has an inner surface 128 defining a cavity 130. The first end 118 of the main body 112 includes a first threaded portion 132 and the second end 122 of the main body 112 includes a second threaded portion 134. In certain embodiments, the first threaded portion 132 and the second threaded portion 134 include external threads as shown in FIGS. 1-5.

The main body 112 may be cylindrical in shape in certain embodiments of the disclosure as shown in FIGS. 1-5. It should be appreciated that the main body is not limited to any particular shape, however, and one of ordinary skill in the art may select another suitable shape, as desired. The main body 112 has a main body diameter 136. In certain embodiments, the main body diameter 136 according to one embodiment of the disclosure is between one inch (1″) and three inches (3″). In a most particular embodiment, the main body diameter 136 is two inches (2″) in length, however, the main body diameter 136 may be any suitable length, as desired.

In certain embodiments, the main body diameter 136 is constant along a length 138 of the main body 112 extending from the first opening 120 of the main body 112 to the second opening 124, for example, as shown in FIGS. 1-5. The main body diameter 136 may vary along the length 138 of the main body 112 in certain embodiments. In certain embodiments of the present disclosure, the length 136 of the main body 112 is between six inches (6″) and eighteen inches (18″). In a most particular embodiment, the length 136 of the main body 112 is twelve inches (12″), however, one of ordinary skill in the art may select another suitable length, as desired.

The main body 112 may be made from any suitable rigid material including, but not limited to, carbon steel, alloy steel, stainless steel, plastic, and iron. Other suitable materials for the main body 112 may also be selected by one skilled in the art within the scope of the present disclosure. The inner surface 128 of the main body 112 is smooth according to particular embodiments of the disclosure.

With renewed reference to FIGS. 1-5, the airflow conduit 114 of the gas purging device 100 is disposed through the major exterior wall 126 of the main body 112. The airflow conduit 114 is positioned equidistant between the first opening 120 of the main body 112 and the second opening 124 of the main body 112 according to certain embodiments of the present disclosure. A skilled artisan may position the airflow conduit 114 anywhere along the major exterior wall 126 of the main body 112, as desired. The airflow conduit 114 is integral with main body 112 in certain embodiments. In other embodiments, the airflow conduit 114 is permanently or semi permanently attached to the main body 112.

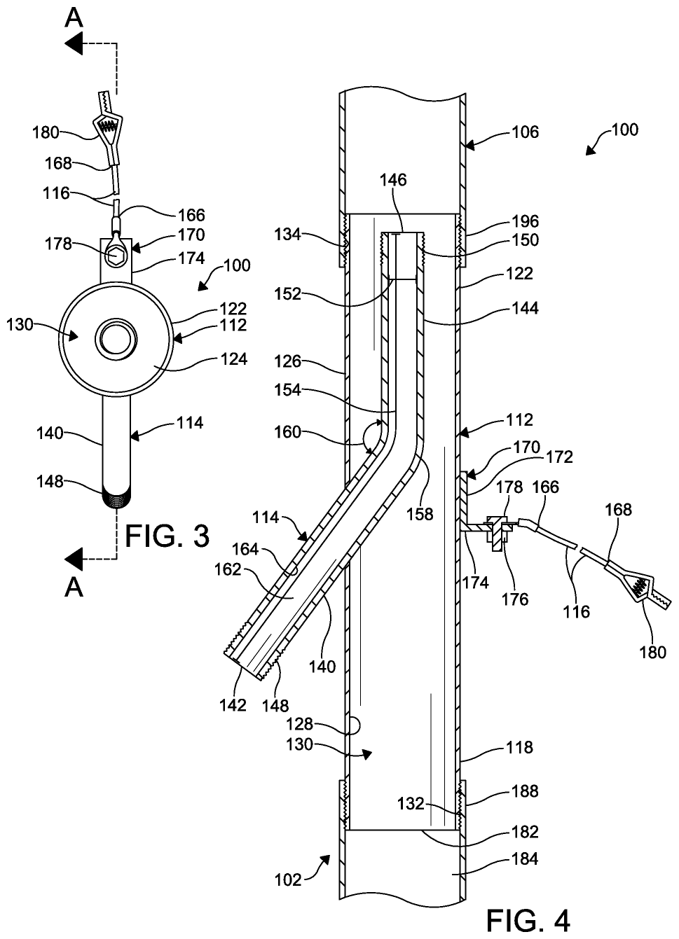

The airflow conduit 114 has a first section 140 and a second section 144. The first section 140 of the airflow conduit is outside of the major exterior wall 126 and has an air inlet 142. The second section 144 of the airflow conduit 114 is disposed in the cavity 130 of the main body 112 and has an air outlet 146, as shown in FIGS. 4 and 5.

The first section 140 of the airflow conduit 114 includes a threaded portion 148 adjacent the air inlet 142. In certain embodiments, the threaded portion 148 includes external threads as shown in FIGS. 1 and 2. In certain embodiments, a threaded portion 150 is disposed on the second section 144 of the airflow conduit 114 adjacent the air outlet 146. Although the second section 144 of the airflow conduit 114 is shown to include the threaded portion 150 in FIGS. 1-5, it should be understood that in certain embodiments of the disclosure the second section 144 of the airflow conduit 114 does not include the threaded portion 150.

As shown in FIG. 1, the air outlet 146 may be flush with or coplanar with the second opening 124 of the main body 112 in certain embodiments of the disclosure, as shown in FIG. 1. One of ordinary skill in the art may also position the air outlet 146 within the cavity 130 of the main body such that the second section 144 of the airflow conduit 114 terminates prior to the second opening 124 of the main body 112, as shown in FIG. 4. In various other embodiments, the airflow conduit 114 may terminate outside of the main body 112 such that the second section 144 of the airflow conduit 114 extends outwardly beyond the second opening 124 of the main body 122, as desired.

In certain embodiments of the present disclosure, the airflow conduit 114 is cylindrical in shape, however, one of ordinary skill in the art may select any suitable shape, as desired. The airflow conduit 114 has a conduit diameter 152. The conduit diameter 152 according to one embodiment of the disclosure is between about one quarter of an inch (0.25″) and one inch (1″). In a most particular embodiment, the conduit diameter 152 is about one half of an inch (0.5″) in length. However, the conduit diameter 152 may be any suitable length, as desired. The conduit diameter 152 is less than the main body diameter 136. In certain embodiments, the conduit diameter 152 is constant along a length 154 of the airflow conduit 114 extending from the air inlet 142 to the air outlet 146, for example, as shown in FIGS. 4 and 5. The conduit diameter 152 may vary along the length 154 of the airflow conduit 114 in certain other embodiments. One of ordinary skill in the art may select any suitable length 154 of the airflow conduit 114, as desired.

The airflow conduit 114 is disposed through the major exterior wall 126 of the main body 112. In a most particular embodiment, the airflow conduit 114 is disposed through the major exterior wall 126 at an angle 156 of about ninety degrees (90°) or less. One of ordinary skill in the art may select any suitable angle, as desired. In a particular embodiment, the airflow conduit 114 is disposed through the major exterior wall 126 at an angle 156 between about twenty-one degrees (21°) and forty-one degrees (41°). In a most particular embodiment, the airflow conduit 114 is disposed through the major exterior wall 126 at an angle 156 of about thirty-one degrees (31°).

The airflow conduit 114 has a curved section 158 disposed between the first section 140 and the second section 144 of the airflow conduit 114. The curved section 158 is disposed adjacent the inner surface 128 within the cavity 130 of the main body 112. The curved section 158 of the airflow conduit 114 bends at an angle 160 in certain embodiments. In certain embodiments, the angle 160 of the curved section 158 is an angle 160 of about ninety degrees (90°) or greater. In a particular embodiment the angle 160 of the curved section 158 is between about one hundred degrees (100°) and one hundred and forty degrees (140°). In a most particular embodiment, the angle 160 of the curved section 158 is about one hundred and twenty degrees (120°).

The curved section 158 of the airflow conduit 114 positions the second section 144 to be parallel to the main body 112. In certain embodiments where the main body 112 and the airflow conduit 114 are cylindrical in shape, the main body 112 and the airflow conduit 114 are concentric. One of ordinary skill in the art may position the airflow conduit 114 in other locations within the cavity 130 of the main body 112, as desired.

The airflow conduit 114 may be made from any suitable rigid material including, but not limited to, carbon steel, alloy steel, stainless steel, plastic, and iron. Other suitable materials for the airflow conduit 114 may also be selected by one skilled in the art within the scope of the present disclosure. An inner surface 164 of the airflow conduit 114 is smooth according to particular embodiments of the disclosure.

The grounding wire 116 has a first end in communication with the main body 112 of the gas purging device 100, and a second end 168 in communication with the grounding rod 108, for example, as shown in FIG. 5. In certain embodiments, as shown in FIGS. 1-5, the major exterior wall 126 of the main body 112 includes a tab 170 that is integral with the main body 112. The tab 170 is permanently or semi-permanently connected to the major exterior wall 126 of the main body 112 in other embodiments of the present disclosure. The tab 170 is L-shaped in a particular embodiment of the disclosure with a first side 172 connected to the major exterior wall 126 of the main body 112 and a second side 174 extending outwardly from the major exterior wall 126 and the first side 172 of the tab 170. It should be appreciated that the tab 170 is not limited to any particular shape, and one of ordinary skill in the art may select any suitable shape for the tab 170, as desired. The first end 166 of the grounding wire 116 is connected to the tab using a nut 176 and a bolt 178 in certain embodiments. Any suitable attachment means may be used to connect the first end 166 of the grounding wire 116 to the tab 170.

The second end 168 of the grounding wire 116 is connected to a clamp 180 using any suitable connecting means. In certain embodiments the clamp 180 is an alligator clamp as shown in FIG. 5, however, a skilled artisan may select any clamping mechanism capable of semi-permanently connecting the grounding wire 116 to the grounding rod 108.

The grounding wire 116 is made from copper in certain embodiments. However, a skilled artisan may select any electrically conductive material for the grounding wire 116, as desired. The tab 170, the nut 176, the bolt 178, and the clamp 180 are made from one or more electrically conductive materials including copper, steel, and aluminum, as non-limiting examples.

In operation, the gas purging device 100, in combination with the gas line 102, the air compressor 104, the purging stack 106, and the grounding rod 108, may form a gas purging system 110 used for purging residual natural gas or other hazardous gas from the gas line 102, as shown in FIG. 5.

The first end 118 of the main body 112 of the gas purging device 100 connects to the gas line 102, and, more specifically, to an outlet 182 including an outlet branch pipe 184 and a gate valve 186. The gate valve 186 is a rotatable valve in certain embodiments of the present disclosure. The outlet has a section of threads 188 adapted to connect to the first threaded portion 132 of the main body 112. In a most particular embodiment, the section of threads 188 includes internal threads and is adapted to connect to the external threads of the first threaded portion 132 of the main body 112. The gas line 102 also has an inlet 190 including an inlet branch pipe 192 and an inlet valve 194 through which air from the atmosphere can enter the gas line 102.

Advantageously, the gas purging device 100 can be directly connected to the gas line 102 in a fast, convenient, user-friendly way. A further advantage is that the gas line 102 can be deactivated independently from the gas purging device 100.

The second end 122 of the main body 112 of the gas purging device 100 is connected to the purging stack 106. In certain embodiments, the second threaded portion 134 of the second end 122 of the gas purging device 100 includes external threads that are received by a section of threads 196 disposed on the purging stack 106. In certain embodiments, the purging stack 106 may include a plurality of purging pipes (not shown) adapted to connect to one another. Advantageously, a height (not shown) of the purging stack 106 is adjustable according to various industry requirements for expelling hazardous gas into the atmosphere. In certain embodiments, the purging stack 106, including the plurality of purging pipes, and the gas purging device 100 is sold as a kit.

The air compressor 104 is connected to the airflow conduit 114. More specifically, threaded portion 148 of the air inlet 142 of the airflow conduit 114 is adapted to be received by an air compressor 104. The angle 156 at which the airflow conduit 114 is disposed through the major exterior wall 126 of the main body 112 allows for quick and easy connection of the air purging device 100 to the air compressor.

The second end 168 of the grounding wire 116 is connected to the grounding rod 108 using the clamp 180. The grounding wire 116 directs dangerous electrical current to the grounding rod 108.

During operation, and once the gas purging device 100 is properly connected to the gas line 102, the purging stack 106, the air compressor 104 and the grounding rod 108, the air compressor 104 is activated, and compressed air is forced through the airflow conduit 114 at a high velocity along a first airflow pathway 198. More specifically, compressed air from the air compressor 104 enters the air inlet 142 of the airflow conduit 114 and travels through the first section 140, the curved section 158, and the second section 144 of the airflow conduit 114 prior to being expelled out of the air outlet 146 of the airflow conduit 114, into the purging stack 106 and out into the atmosphere. The angle 160 of the curved section 158, the constant diameter 152, and the smooth inner surface 164 of the airflow conduit 114 allow the compressed air to move along the first airflow pathway 198 efficiently and without unnecessary impedance.

The compressed air traveling along the first airflow pathway 198, once expelled from the air outlet 146 of the airflow conduit 114 creates a negative pressure or vacuum in the cavity 130 of the main body 112 due to the Venturi effect. As a result, hazardous gas from the gas line 102 is pulled through the outlet 182 of the gas line 102 by way of the outlet branch pipe 184 when the gate valve 186 is in an open position. As the hazardous gas leaves the gas line 102 and enters the main body 112 of the gas purging device, inert air is pulled from the atmosphere through the inlet 190 of the gas line 102 by way of the inlet branch pipe 192 when the inlet valve 194 is in an open position. Advantageously, inert air from the atmosphere travels along a second airflow pathway 200 from the atmosphere into the gas line 102 and replaces the hazardous gas as it is pulled from the gas line 102, through the gas purging device 100 and the purging stack 106 and out into the atmosphere.

Advantageously, the gas purging device 100 is adaptable and easily connects directly to the gas line 102, the air compressor 104, and the purging stack 106 and is convenient to use, cost effective, and compliant with variable industry standards. Safety features including the grounding wire 116 permit safe working environments. Advantageously, the air compressor 104 can expel compressed air at varying speeds without causing pressure to build up the gas line 102. More specifically, the hazardous gas from the gas line 102 is pulled into the atmosphere at varying speeds without unnecessary pressure build up in the gas line 102 because the air compressor 104 operates independently from the gas line 102. Additionally, because the gas purging device 100 in combination with the air compressor 104 operates independently from the gas line 102, the gate valve 186 can be closed in the event of an emergency independently from the gas purging device 100.

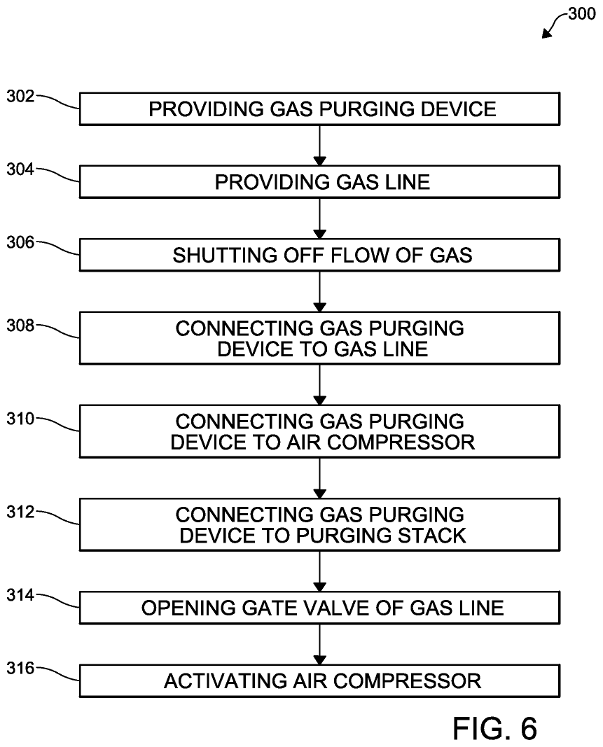

A method 300 for purging gas from the gas line 102 using the gas purging device 100 is shown in FIG. 6. The method of purging gas from a gas line 102 includes a first step 302 of providing a gas purging device 100 according to various embodiments of the present disclosure. In a second step 304, a gas line 102 in need of maintenance, repair, or closing off is identified and provided. The method further includes the additional steps 306, 308, 310, 312, 314 of shutting off a flow of gas to the gas line 102, connecting the first end 118 of the main body 112 of the gas purging device 100 to the air outlet 182 of the gas line 102, connecting the first section 140 of the airflow conduit 114 of the gas purging device 100 to an air compressor 104, connecting the second end 122 of the main body 112 of the gas purging device 100 to a purging stack 106, and opening the inlet valve 194 of the gas line 102 and the gate valve 186 of the gas line 102. A final step 316 is activating the air compressor 104 to cause a first flow of air 198 through the airflow conduit 114 into the purging stack 106 at a high velocity, whereby, due to the Venturi effect, the first flow of air 198 creates a negative pressure in the cavity 130 of the main body 112 of the gas purging device 100 that pulls the second flow of air 200 from the gas line 102, through the purging stack 106, and into the atmosphere.

The method for purging gas from the gas line 102 may further include the steps of excavating the gas line 102 in an area surrounding the air outlet 182 of the gas line 102 and adding additional purge pipes (not shown) to the purging stack 106 in order to meet industry requirements prior to connecting the first end 118 of the main body 112 of the gas purging device 100 to the air outlet 182 of the gas line 102.

Upon completion of gas removal from the gas line 102, the inlet valve 194 and the gate valve 186 of the gas line 102 are closed thereby sealing the depressurized gas line 102. The air compressor 104 is deactivated, the purging stack 106 is disconnected from the gas purging device 100, the grounding wire 116 is disconnected from the grounding rod 108, and the air purging device 100 is disconnected from the gas line 102.

Advantageously, the gas purging device 100 of the present disclosure has been found to be convenient and easy-to-use, adaptable to various industry standards, and cost effective. Furthermore, the gas purging device 100 may advantageously connect directly to the gas pipeline 102 while operating independently from a controlled gas line shut-off, as described herein.

While certain representative embodiments and details have been shown for purposes of illustrating the invention, it will be apparent to those skilled in the art that various changes may be made without departing from the scope of the disclosure, which is further described in the following appended claims.

What is claimed is:

1. A gas purging device, comprising:
a main body having a first end and a second end, the first end defining a first opening, and the second end defining a second opening, and the main body having a major exterior wall extending from the first end to the second end, the major exterior wall having an inner surface that defines a cavity of the main body, the cavity in fluid communication with the first opening and the second opening of the main body;
an airflow conduit disposed through the major exterior wall of the main body and having a first section and a second section, the first section disposed outside of the main body and having an air inlet, and the second section disposed in the cavity and having an air outlet; and
a grounding wire that is in electrical communication with the major exterior wall of main body.

2. The gas purging device of claim 1, wherein the airflow conduit is disposed through the major exterior wall of the main body equidistant from the first end and the second end of the main body.

3. The gas purging device of claim 1, wherein each of the first end and the second end of the main body has a threaded section.

4. The gas purging device of claim 1, wherein the main body is a cylinder having a first diameter, and the airflow conduit is a cylinder having a second diameter, and wherein the first diameter is greater than the second diameter.

5. The gas purging device of claim 4, wherein the first diameter is consistent from the first end to the second end of the main body.

6. The gas purging device of claim 4, wherein the second diameter is consistent from the air inlet to the air outlet of the airflow conduit.

7. The gas purging device of claim 1, wherein a length of the main body extending from the first end to the second end is between about six inches (6″) and about eighteen inches (18″).

8. The gas purging device of claim 1, wherein the first section of the airflow conduit is positioned adjacent the major exterior wall of the main body at an angle of about ninety degrees (90°) or less.

9. The gas purging device of claim 4, wherein the airflow conduit further includes a curved section connecting the first section with the second section, the curved section disposed adjacent the inner surface of the main body, the curved section positioning the second section of the airflow conduit to be concentric with the main body.

10. The gas purging device of claim 9, wherein the curved section of the airflow conduit bends at an angle of about ninety degrees 90°) or greater.

11. The gas purging device of claim 1, wherein the air outlet of the airflow conduit is one of coplanar with and disposed under the second opening at the second end of the main body.

12. The gas purging device of claim 1, further comprising a first airflow pathway and a second airflow pathway, the first airflow pathway being separate from the second airflow pathway, with the first airflow pathway disposed between the inner surface of the major exterior wall of the main body and an outer surface of the airflow conduit, and the second airflow pathway disposed within the airflow conduit.

13. The gas purging device of claim 1, wherein the grounding wire is connected to an electrically conductive tab disposed on the major exterior wall of the main body.

14. The gas purging device of claim 13, wherein the electrically conductive tab is disposed opposite the airflow conduit on the major exterior wall and equidistant from the first end and the second end of the main body.

15. The gas purging device of claim 1, wherein the airflow conduit has a threaded section adapted to connect to an air compressor.

16. A gas purging system, comprising:
a gas purging device having a main body having a first end and a second end, the first end defining a first opening, and the second end defining a second opening, and the main body having a major exterior wall extending from the first end to the second end, the major exterior wall having an inner surface that defines a cavity of the main body, the cavity in fluid communication with the first opening and the second opening of the main body, an airflow conduit disposed through the major exterior wall of the main body and having a first section and a second section, the first section disposed outside of the main body and having an air inlet, and the second section disposed in the cavity and having an air outlet, and a grounding wire that is in electrical communication with the major exterior wall of main body;
a gas line having a first end and a second end, the first end having a gas line air inlet and the second end having a gas line air outlet, the gas line air inlet having an inlet valve disposed therein and the gas line air outlet having a gate valve disposed therein, the gate valve in communication with the gas purging device;
an air compressor in fluid communication with the air inlet of the airflow conduit of the gas purging device; and
a purging stack in fluid communication with the second end of the main body of the gas purging device.

17. The gas purging system of claim 16, wherein the main body is a cylinder having a first diameter and the airflow conduit is a cylinder having a second diameter, and wherein the first diameter is greater than the second diameter.

18. The gas purging system of claim 17, wherein the first diameter is consistent from the first end to the second end of the main body and the second diameter is consistent from the air inlet to the air outlet of the airflow conduit.

19. A method for purging gas from a gas line, the method comprising:
providing a gas purging device, the gas purging device having a main body having a first end and a second end, the first end defining a first opening, and the second end defining a second opening, and the main body having a major exterior wall extending from the first end to the second end, the major exterior wall having an inner surface that defines a cavity of the main body, the cavity in fluid communication with the first opening and the second opening of the main body, an airflow conduit disposed through the major exterior wall of the main body and having a first section and a second section, the first section disposed outside of the main body and having an air inlet, and the second section disposed in the cavity and having an air outlet, and a grounding wire that is in electrical communication with the major exterior wall of main body
providing a gas line, the gas line having a first end and a second end, the first end having a gas line air inlet and the second end having a gas line air outlet, the gas line air inlet having an inlet valve disposed therein and the gas line air outlet having a gate valve disposed therein, the gate valve in communication with the gas purging device;
shutting off a flow of gas to the gas line;
connecting the first end of the main body of the gas purging device to the gas line air outlet of the gas line;
connecting the first section of the airflow conduit of the gas purging device to an air compressor;
connecting the second end of the main body of the gas purging device to a purging stack;
opening the inlet valve of the gas line and the gate valve of the gas line; and
activating the air compressor to cause a first flow of air through the airflow conduit into the purging stack at a high velocity, whereby, due to the Venturi effect, the first flow of air creates a negative pressure in the main body of the gas purging device that pulls a second flow of air from the gas line, through the purging stack, and into the atmosphere.

20. The method of claim 19, further comprising a step of closing the gate valve of the gas line to stop the second flow of air from entering the main body of the gas purging device when the gas purging device is in use.
